(19) United States
(12) Patent Application Publication
(10) Pub. No.: US 2022/0132876 A1
(43) Pub. Date: May 5, 2022

(54) Agglomerated Flavor Composition

(71) Applicants: Mark A. Stout, Twin Falls, ID (US); Brent L. Petersen, Twin Falls, ID (US)

(72) Inventors: Mark A. Stout, Twin Falls, ID (US); Brent L. Petersen, Twin Falls, ID (US)

(21) Appl. No.: 17/575,572

(22) Filed: Jan. 13, 2022

Related U.S. Application Data
(63) Continuation of application No. 16/512,347, filed on Jul. 15, 2019, now abandoned.
(60) Provisional application No. 62/697,996, filed on Jul. 13, 2018.

(51) Int. Cl. A23B 7/024; A23B 7/04; A23P 10/30; A23L 2/52; A23P 10/20

(52) U.S. Cl. CPC A23B 7/024; A23B 7/0408; A23P 10/20; A23L 2/52; A23P 10/30

(57) ABSTRACT

Disclosed herein are compositions comprising agglomerates formed of fruit flakes and target ingredients, such as flavorings, colorings, aromatic particles, nutrients, etc. Also disclosed are methods for making fruit flake agglomerates that can deliver higher concentrations of flavorings, colorings, aromatic particles, nutrients, etc.

### FIELD OF THE INVENTION

The invention relates to flavorings for food, confectioneries, etc. More specifically, the invention relates to compositions for adding flavor, color, other particulate products, or combinations thereof, to edible compositions.

### BACKGROUND OF THE INVENTION

Flavor, color, and aroma play an important role in influencing consumer food selection, food consumption, and satisfaction. The flavor industry had a market value of about $11 billion USD in 2012 and increased to $12 billion USD in 2014. About 20-25% of all flavors are estimated to be sold in an encapsulated form, with most (80-90%) of the encapsulates being prepared using the spray-dried method, followed by spray chilling (5-10%), melt extrusion (2-3%), and preparation by melt injection (2%).

Added flavor or coloring can be encapsulated using a carrier and a coating, for example, keeping in mind that this combination must be selected to protect the flavor composition from degrading or evaporating during storage and to provide release in the finished product in the desired amount and at the appropriate time. A variety of coating compositions have been used in compositions that release flavor, colorants, aroma, or combinations of these three Some of these coatings include, for example, starch, maltodextrins, chitosan, corn syrup solids, dextrin, modified starch, cyclodextrins, carboxymethyl cellulose, methyl cellulose, ethyl cellulose, cellulose acetate phthalate, cellulose acetate butylate-phthalate, gum acacia, agar, sodium alginate, carrageenan, wax, paraffin, beeswax, diacylglycerols, oils, fats, gluten, casein, gelatin, albumin, and protein/peptides. However, as consumers increasingly search for products that incorporate fewer “artificial” ingredients, and that are generally categorized as “clean label,” it is desirable to identify and develop methodologies that provide added flavor, color, and/or aroma to food and/or beverage compositions without the use of unnecessary or unfamiliar additives. It is also desirable to develop food compositions using more natural ingredients, and to develop delivery mechanisms that contain increased amounts of flavoring, especially when the intended use of flavorings is production of beverages, nutritional drinks, and other liquid products in which flavor concentrates will be dispersed—and therefore diluted—into liquid.

The process of spraying flavors or colorants onto carriers is commonly used as a means to deliver flavor or color to a product. One limitation of this process, however, is the natural limit on how much flavor can be plated onto a particle as the result of spray-drying. Compounds which are not easily solubilized are also difficult to plate onto a product using this process. What are needed, then, are better approaches to the production of flavor carriers so that the amount of flavor, color, added nutrients, etc., can be increased and optimized.

### SUMMARY OF THE INVENTION

The invention relates to a method for making ingredient delivery particles comprising dried fruit flakes, the method comprising co-agglomerating at least one target ingredient with dried fruit flakes to produce an agglomerate that encapsulates the at last one target ingredient within the dried fruit flakes. In various embodiments, the dried fruit flakes are drum-dried fruit flakes. In various embodiments, the at least one target ingredient comprises dry, or dried, particles selected from the group consisting of one or more flavoring, coloring, vitamin, mineral, nutritional supplement, functional ingredient (such as, for example, thickeners, texturizers, and/or emulsifiers), or a combination thereof.

The invention provides a novel method of use for an agglomerator, the method comprising rapidly dissolving thin fruit flakes and drying them so that they to adhere to each other without forming clumps, the steps of the method being readily performed in an automated fashion within an agglomerator. The adhered flakes form larger particles that can readily bind to and/or encompass powders. This method is utilized to agglomerate at least one fruit flake and at least one target ingredient, the method comprising the steps of admixing the at least one fruit flake and at least one dry-particle target ingredient to produce a fruit flake/target ingredient mixture; adding the flake/target ingredient mixture to an agglomerator and slowly wetting the flake/target ingredient mixture at a temperature of from about 40 to about 60 degrees Celsius until the at least one target ingredient is substantially incorporated into agglomerates formed by the combination of the at least one fruit flake and the at least one target ingredient; and drying the agglomerates prior to packaging. In various embodiments, the fruit flake/target ingredient mixture comprises from about 40 to about 70 percent fruit flakes and from about 25 to about 60 percent target ingredient, by dry weight of the mixture. In various embodiments, the method further comprises the step of adding at least one liquid colorant, flavor, or at least one combination thereof, to the fruit flake/target ingredient mixture to coat the agglomerate as the fruit flakes begin to deform (i.e., undergo conformational change), further concentrating the flavor, color, etc.

### BRIEF DESCRIPTION OF THE DRAWINGS

FIG. 1 is a photomicrograph of un-agglomerated drum-dried strawberry fruit flakes, 4× magnification.

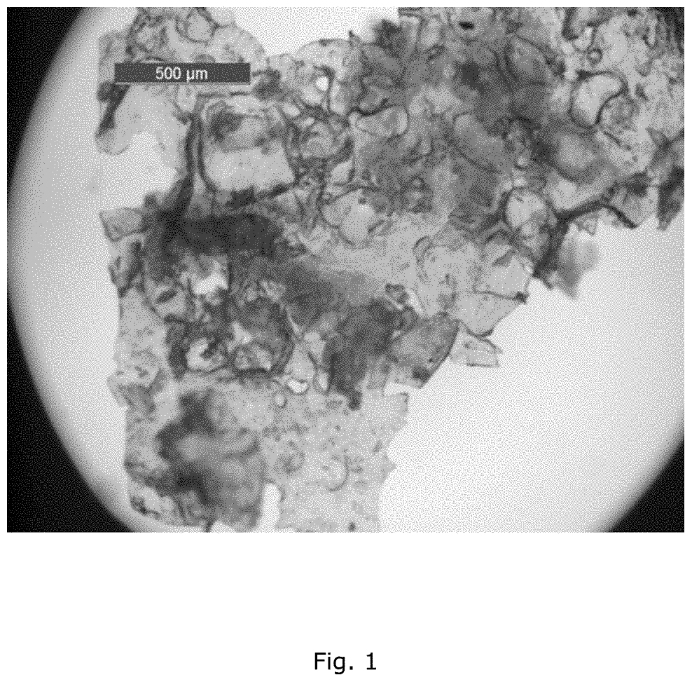

FIG. 2 is a photomicrograph of un-agglomerated drum-dried strawberry fruit flakes, 4× magnification.

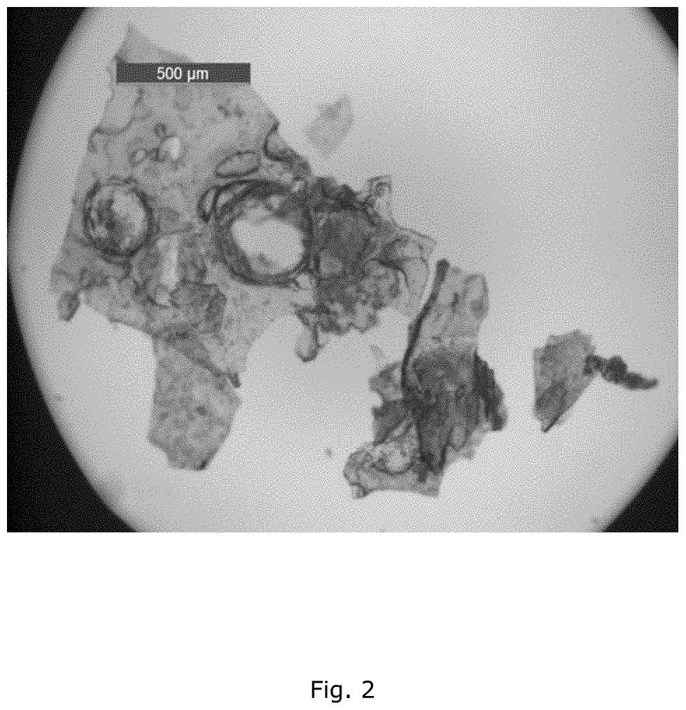

FIG. 3 is a photomicrograph of agglomerated drum-dried strawberry fruit flakes, 4× magnification. Yellow and blue powders were added in order to more easily visualize the incorporated powder components.

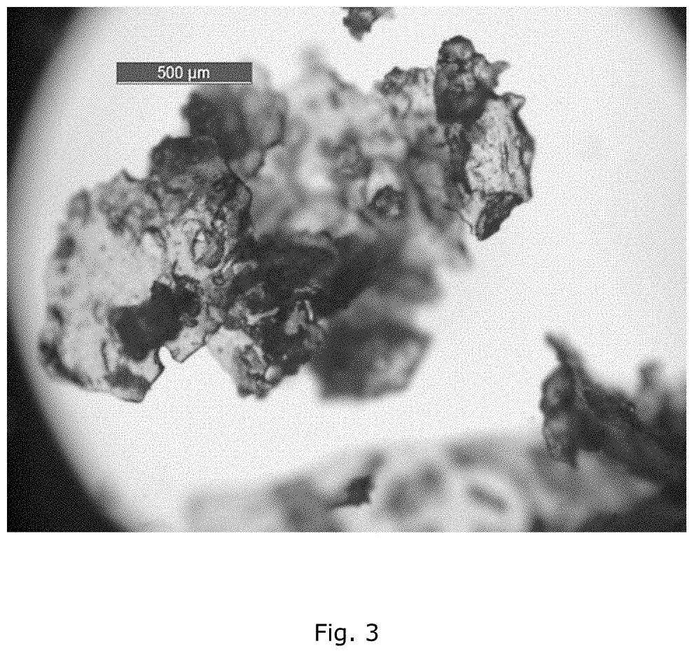

FIG. 4 is a photomicrograph of agglomerated drum-dried strawberry fruit flakes, 4× magnification. Yellow and blue powders were added in order to more easily visualize the incorporated powder components.

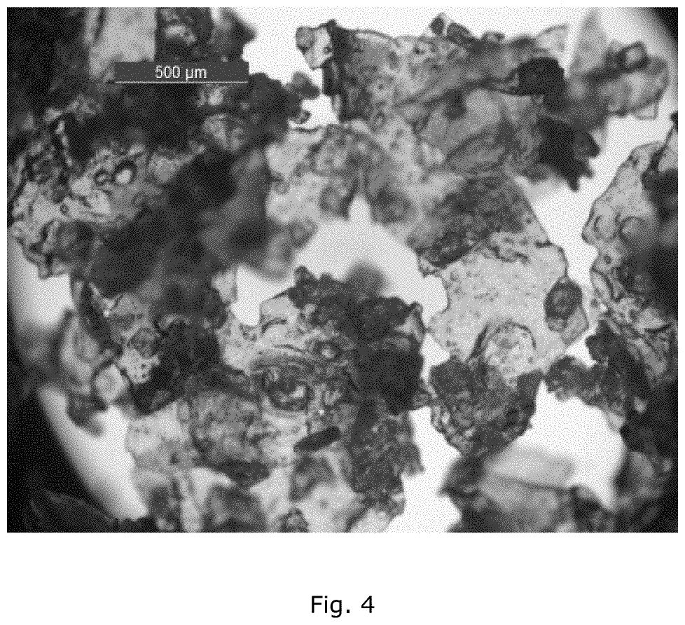

FIG. 5 is a photomicrograph of un-agglomerated drum-dried strawberry fruit flakes, 10× magnification.

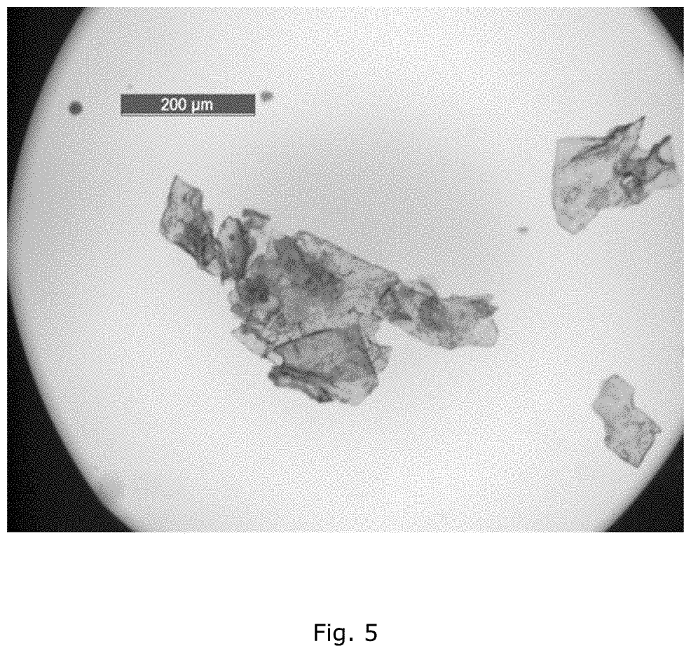

FIG. 6 is a photomicrograph of agglomerated drum-dried strawberry fruit flakes, 10× magnification. Yellow and blue powders were added in order to more easily visualize the incorporated powder components.

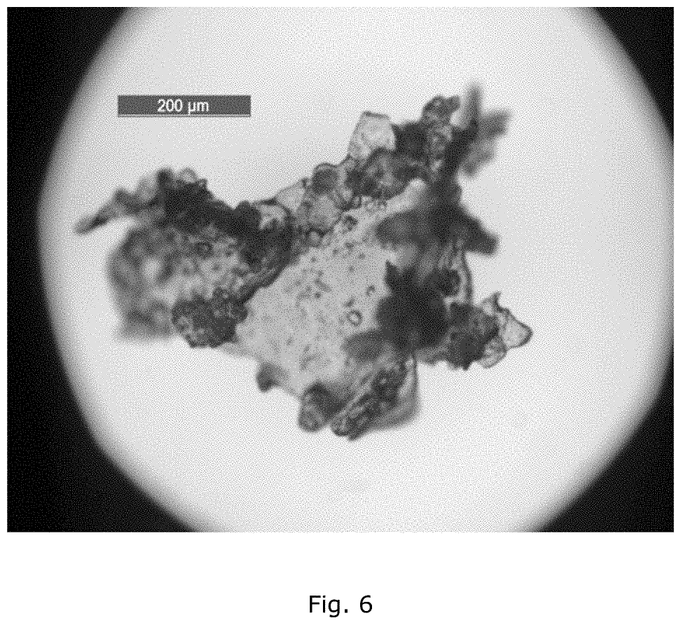

### DETAILED DESCRIPTION

The inventors have discovered a method whereby fruit flakes can be wetted and dried under agitation to promote conformational change in the fruit flakes, thereby promoting encapsulation of one or more ingredients within the fruit flake agglomerates, as well as binding of the one or more ingredients to those agglomerates when the flakes and one or more ingredient are co-agglomerated. This method does not require the addition of a binder, plasticizer, or other additive commonly used to promote the formation of agglomerates, giving a formulator the opportunity to provide a “clean label” agglomerated product to a consumer. The invention relates to a method for agglomerating at least one fruit flake and at least one target ingredient, the method comprising the steps of admixing the at least one fruit flake and at least one dry-particle target ingredient to produce a fruit flake/target ingredient mixture; adding the fruit flake/target ingredient mixture to an agglomerator and slowly wetting the fruit flake/target ingredient mixture at a temperature of from about 40 to about 60 degrees Celsius until the at least one target ingredient is substantially incorporated into agglomerates formed by the combination of the at least one fruit flake and the at least one target ingredient. “Substantially incorporated” means that as much of the target ingredient has been incorporated into agglomerates formed of the at least one fruit flake and the at least one target ingredient as is practicable. This process can be continued until an appropriate adherence of flake and powder is achieved and the product is sufficiently dried. In various embodiments, the fruit flake/target ingredient mixture comprises from about 40 to about 70 percent fruit flakes and from about 25 to about 60 percent target ingredient, by dry weight of the mixture. In various embodiments, the method further comprises the step of adding at least one liquid colorant, flavor, or at least one combination thereof, to the fruit flake/target ingredient mixture to coat the agglomerate as the fruit flakes begin to deform.

Fruit flakes are commercially available from a variety of sources. They are made by pureeing fresh fruits and/or vegetables and drying them, usually in a drum dryer, to produce a thin and flaky product which can be milled to different flake or powder sizes. The term “fruit flake” has been used herein for consistency. However, those of skill in the art will recognize that some vegetable products and other plant products, such as those used for nutritional supplementation, may have similar characteristics to those of “fruit” flakes and it may be desirable to use flakes produced from those sources in some product applications. For example, vegetable flakes agglomerated with target ingredients comprising seasonings that complement the taste of the vegetable from which the flakes are made, could be produced to increase the flavor of products such as baby foods, portable non-refrigerated foods such as meals-ready-to-eat (MREs), etc. Therefore, where the term “fruit flake” is used, it is to be understood that the term can encompass fruit flakes, vegetable flakes, and other similar plant-derived product flakes, depending upon the product to be manufactured.

Agglomerators have been in use in the food industry for years, and the process is standardly known to involve the use of a binder composition fed into (“charged” into) the agglomerator to bind together particles of compositions such as proteins, peptides, etc., to produce clumps of ingredients, or agglomerates. The most common binder used in these applications is lecithin. However, there are reasons, such as consumer concerns over the incorporation of that ingredient in foods, and in some cases, lecithin intolerance in specific individuals, for reducing the ingredients in an agglomerate to only those that are necessary to provide the desired flavor, color, nutrient, aroma, etc. Unlike traditional agglomeration, the present method does not promote binding through incorporation of a binding agent such as lecithin, but instead utilizes the melting, drying, and deformation of the flake particle itself to provide unique binding characteristics without requiring the use of binders, fats, etc.

The inventors have therefore developed a method for encapsulating ingredients for incorporation into foods, beverages, and other edible products, the method comprising co-agglomerating fruit flakes (i.e., at least one fruit flake, at least one type of fruit flake, etc.) with at least one target ingredient, using the combination of heat, wetting, and drying to produce a conformational change in the fruit flakes that promotes encapsulation and/or adherence of the at least one target ingredient within the agglomerated fruit flakes. In various aspects of the method, some of the at least one target ingredient can also be adhered onto the fruit flake agglomerate, as well. The invention therefore provides a method for delivering a dry/dried particulate flavor, color, or other additive into a food or beverage application by sealing the dry additive in a porous structure formed by dried fruit and/or vegetable particles (“fruit flakes”). As the agglomerated particle dissociates when it comes into contact with a sufficient amount of water, which may be in the form of moisture in a liquid or semi-liquid product, for example, a flavorant and/or colorant, for example, can freely be delivered for incorporation into the product.

The inventors have also developed fruit-flake ingredient carriers, sealing powdered additive(s) into the porous structure of at least one fruit flake, by coating the at least one fruit flake with at least one target ingredient and a food safe lipid (e.g., coconut oil) which will easily dissociate from the particle in aqueous solutions or in the presence of increased heat. When heat and/or water is applied, the target ingredient is incorporated into the food or beverage product into which the fruit-flake carriers are admixed. In this method, freeze-dried fruit flakes and at least one target ingredient (e.g., at least one powdered flavorant and/or colorant) are weighed separately, the ratio of freeze-dried fruit product to additive being product—and application—specific. The food-safe fat source (coconut oil, for example) is weighed, and melted to a liquid state. The freeze-dried fruit product is added to a tumbling panner and small amounts of target ingredient and liquidized fat are added, in an alternating manner, into the panner until all product is incorporated. The product is tumbled until the fat has solidified, producing a coated agglomerate formed of at the least one fruit flake and at least one target ingredient. This technique may also be used to coat agglomerates made by the present method, as well.

Agglomerates made by the method of the present invention can provide flavor, color, etc. well beyond the ranges of that provided by typical conventionally-used methods of spraying flavor onto a carrier, especially a carrier comprising at least one fruit flake. They are also unique in that they can do this without requiring any external binders or delivery mechanisms other than the fruit flakes.

The invention therefore provides a method for delivering a powdered flavor, color, or other dry particle into a food or beverage product by incorporating the dry particle into a product comprising fruit modified to bind and encapsulate powder(s). The product is made by a method comprising wetting, heating, and mixing thin flakes of fruit with at least one powdered flavor, color, or other dry particle to produce fruit/dry particle agglomerates. Agglomeration is known to produce an increase in particle size and a more porous particle structure that generally improves penetration of a liquid into a particle. This can be advantageous in terms of dissolution of the particle when it comes in contact with an aqueous environment, or an environment that contains sufficient moisture to promote dissolution of the particle and release of the target ingredient(s). This will also allow a particle to appear large in a powdered application without comprising a large percentage of the total weight. A commercially-available agglomerator apparatus, such as those sold by companies like Glatt GmbH (Germany), for example, can be used to perform the method. The method can be performed using continuous processing, or by batch processing.

The present method utilizes both the heat and agitation produced within the agglomerator to promote adherence of the wetted flakes to each other. As the flakes adhere to each other, powders added during the agglomeration process are either captured within the agglomerates as they are formed, resulting the encapsulation of powder(s) added during the agglomeration process, or adhered to a portion of the particle itself. Changes in the size, shape, and density of individual flakes can occur through the heating, wetting, and drying process. These changes provide a natural encapsulation option, eliminating the need for the addition of compounds that generally act as binding agents (such as maltodextrin or fat). Those types of compounds can be used in the application, if desired, to increase yield or decrease risk of powder sedimentation during transport, but if a formulator is targeting a cleaner-label, fewer-ingredient option, nothing is needed other than one or more types of fruit flake(s) and one or more dry particulate flavor(s), color(s), or nutrient(s), for example. The flake matrix in an agglomerate produced by this method is easily dissolved in water, providing a delivery mechanism for colors or flavors in wetted applications, or for particles which easily dissolve on the tongue when consumed.

This method uses the high temperature and drying capability of an agglomerator to partially dissolve and deform a fruit flake or other matrix particle with water, before drying the water off. This allows for large particle confirmations that can hold powder, as well as the incorporation of powders into the particle itself. By maintaining a relatively high temperature (e.g., 45-55° C.) and keeping a low flow rate, the fruit pieces come in contact with the water, promoting the dissolution and deformation of the particle. Drying the particle quickly allows larger particles to form as small particles dissolve and dry together, producing large surface areas with unconventional shapes and conformations. In addition to their ability to contain significant amounts of powder(s), these flakes are also much larger and more visible in powders, giving the appearance of many large “flecks” of fruit within a powder using relatively small amounts of flecks by weight.

Agglomeration has previously been used, for example, to increase particle size of proteins by adding a measured quantity of protein to be agglomerated to the interior of an agglomeration chamber, or fluidized bed, of the agglomerator. This process is referred to as “charging.” Air flow directed from the bottom of the agglomeration chamber upwards continuously disperses the powder upward, and wetted molecules are sprayed into the upper part of the agglomeration chamber. As the wetted molecules come into contact with the powder, agglomerates are formed. As the air flow continues to circulate upward, the agglomerated particles and powder come into contact with the wetted binder molecules, forming agglomerates of larger and larger size. When the agglomeration process is complete, the agglomerated protein particles are dried and discharged from the agglomerator. Binders are used to “glue” the agglomerates together during this process.

The inventors, however, discovered that the heating/agitation/wetting provided by an agglomerator sufficiently modifies the shape and structure of the fruit flake carrier and increases the amount of target ingredient that can be associated with it—without requiring the addition of a binder. Fruit flakes have been used as flavor carriers, but previous applications have generally involved spray-drying flavor particles onto the surface of the fruit flakes (https://www.sensientflavorsandfragrances.com/innovations/flavor-delivery, for example). However, with spray-drying there are significant limits to the amount of flavor particles that can be associated with the fruit flakes. Fruit flakes have been coated and then agglomerated, as well, but again, there is a limit to the amount of flavor particles, for example, that can be associated with an individual fruit flake using this method. Uncoated fruit/vegetable flakes have been agglomerated—using rolled flakes combined with other fruit products such as juices, to promote the formation of a more three-dimensional structure for the purpose of producing a pulpy structure from which something such as a slurry can be produced when the fruit flakes are reconstituted (U.S. Pat. No. 6,340,494 to Klukowski, et al). However, a pulpy consistency is not desirable for the delivery of flavorings, colorings, and/or other ingredients into a liquid such as a beverage, for example. The present invention, however, provides a powder that can readily be dispersed to release one or more target ingredients into a product into which the fruit flake/target ingredient agglomerates are added, while providing a significant amount of target ingredient that can be associated with the fruit flake carriers. Products made according to the method of the invention are suitable for adding coloring, flavoring, sweeteners, etc., to liquid beverage compositions without significantly modifying the density and/or mouthfeel of the beverage compositions into which they are incorporated.

In the method of the invention, the ratio of ingredient to fruit flake will depend upon the type(s) of flake used and the type(s) of dry particle used. However, the inventors have determined that excellent agglomerate compositions can be made using 25-60% powder and 40-70% fruit flakes, by dry weight of the total composition. Agglomerates containing even more flavor, color, etc., can be obtained by incorporating flavor, color, etc., into the aqueous phase, thereby plating the surface of the particle in liquid product during the agglomeration process. It should be understood by those of skill in the art that the selection of types of fruit and/or vegetable flakes, the types of particles to be included in the agglomerates, and the type of agglomerator chosen for use will introduce variables into the method of the invention which may require optimization of the method for the particular combination used. Therefore, the flow rate for introducing the fruit flake and target ingredient particles into the agglomerator, the flow rate for wetting, timing, etc., are parameters that standardly require brief experimentation/optimization, depending upon the materials, and the equipment, used. However, this experimentation/optimization is not undue, is common in the field of food science, and is well within the level of expertise of one of skill in the art, given the disclosure provided herein.

The method of the invention may be performed as follows. First, a desired concentration of target ingredient(s) (usually in powder form) is determined, and the appropriate amount weighed. Target ingredients may be selected from among a variety of compositions such as, for example, flavors, colors, vitamins, minerals, proteins, fats, carbohydrates, processing aids, binders, or emulsification agents, caffeine, or bioactive fitness products (such as creatine, β-alanine, or L-carnitine). The weight of the fruit flakes to be used is determined based on the weight of the target ingredient powder(s). Fruit-to-powder concentration ratios will vary, depending on variables such as the type of fruit used, the size and dimension of the flakes, and the density and weight of the powder. These parameters can readily be determined by those of skill in the art using the information provided herein. In various embodiments, however, the fruit flake/target ingredient mixture comprises from about 40 to about 70 percent fruit flakes and from about 25 to about 60 percent target ingredient, by dry weight of the mixture.

Binding agents, which are not required for use in the present method, may be added if desired by one of skill in the art, and may optionally be added to the liquid injected into the agglomerator, into the powder being encapsulated, or incorporated into the fruit flakes as needed. The addition of binding agents may further improve the total binding capacity of the agglomerator heat/water-modified fruit flakes. In one embodiment, the inventors produced a product made up of 60% strawberry fruit flakes and 30% powdered flavoring, as well as 10% plated flavoring supplied in the aqueous phase, without the addition of binding agent. The invention can therefore comprise a method wherein agglomeration of the fruit flakes and target ingredient(s) is accomplished without the addition of binding agent to promote agglomeration.

The fruit and powder, along with any additional additives that may be desired by one of skill in the art, are mixed and placed in an agglomerator, and the agglomerator is then allowed to heat and equilibrate. Heats and settings vary between agglomerators. However, on a Mini-Glatt® series 11220 agglomerator (Glatt® Air Techniques, Inc. Ramsey, N.J., USA), the inventors determined that efficient input temperature ranged from 51-57° C.

Water used for the agglomeration process may contain flavors, binders, colors, or other products as necessary to increase the concentration of these compounds in the finished product. However, when adding these ingredients, formulators should keep in mind that a significant excess of the added ingredients can interfere with efficient fruit flake particle formation.

The desired fruit-flake/target ingredient product is then agglomerated, with relatively slow liquid incorporation (because too much water added too quickly may cause the fruit flakes to clump into an unusable mass). Precise regulation of fluid uptake, as well as temperature, will ensure that flakes are wetted and water evaporates at a rate that promotes the expansion of individual flake agglomerates. This rate of wetting and evaporation should be more rapid than that used in traditional agglomeration, where a wetted particle is allowed to remain hydrated to encourage lecithin-assisted adherence to other particles. Excessive wetting, in this case, will cause the formation of large fruit masses, or pitting, resulting in large, hard, insoluble particles which would not incorporate into solution or release the encapsulated powder. Following agglomeration, the product can be inspected for powder sedimentation before bagging or mixing in the intended end use application. Encapsulation efficiency varies depending on equipment, weights, raw ingredients, and user error, with a powder encapsulation efficiency of <3% (by weight) generally having been observed by the inventors when using this procedure. The resulting flavor-release composition can be added to powdered protein beverages, yogurts, baked goods, sports nutrition products, or other products to provide flavor, nutritional supplementation, and/or, for example, color change as a product is hydrated.

As an example of an advantage of the encapsulation method of the invention, a color-changing product can be produced for a powdered ready-to-drink protein beverage. In this protein beverage application, the flakes appear to be small red flecks in an off-white powder. Once hydrated, the off-white protein beverage will change to a bright red color as the bound colorant solubilizes and disperses into the solution. Additionally, the flakes also provide the entire strawberry flavor and sweet taste to the beverage as the powdered flavorants and sweeteners solubilize in the aqueous solution and disperse into the beverage during hydration.

Where the term “comprising” is used herein, the terms “consisting of” and/or “consisting essentially of” may be substituted therefor, as inventions that “comprise” certain elements or limitations also “consist of” and/or “consist essentially of” those elements or limitations.

The invention may be further described by means of the following non-limiting examples.

### Examples

### Agglomerated Fruit Flake Flavor Composition

The product was manufactured with mesh −4 drum-dried strawberry flakes, powdered strawberry flavor, powdered sweeteners, powdered colorants, liquid colorants, and liquid flavorants. As shown in Table 1, product weights were determined so that 30% of the total product weight was powdered flavorant, sweetener, and colorant. Five percent of the total weight was liquid flavorant and colorant, added to the aqueous phase and injected into the agglomerator during processing. Sixty-five percent (65%) of the final weight was provided by the −4 mesh fruit flakes.

TABLE 1

| Percent Total, | |
|---|---|
| By Weight | Ingredient(s) |
| 30 | Powdered flavorant, sweetener, and colorant |
| 5 | Liquid flavorant and colorant (added to the |
| | aqueous phase and injected into the agglomerator |
| | during processing |
| 65 | Fruit flakes |

Agglomeration was performed at 53° C. in a Mini-Glatt pilot-plant-scale agglomerator using water, liquid red colorant, and liquid strawberry flavor as the liquid. Incorporation rate was set to ensure that the product was wetted but then quickly dried, with the pressure and pulse rates monitored to ensure thorough mixing of the product.

### Density and Size Assessment of Agglomerated Vs Un-Agglomerated

The inventors assessed bulk density of un-agglomerated and agglomerated strawberry fruit flakes by placing 20 g of each sample into a graduated cylinder and measuring the total volume. The cylinder was then tapped firmly 100× on a table to allow for particles to loosely settle. Particle size was performed by the analytical department of Glanbia Nutritionals, Inc. (Twin Falls, Id.). Results are shown in Table 2.

TABLE 2
Bulk density of regular and agglomerated strawberry flakes.

| | Bulk density | Bulk density |
|---|---|---|
| | before tapping | after tapping |
| | (volume of 20 g) | (volume of 20 g) |
| Strawberry Flakes | 92 mL | 64 mL |
| Agglomerated Strawberry | 140 mL | 104 mL |
| Flakes | | |

Average particle size was also assessed for un-agglomerated strawberry flakes and for agglomerated strawberry flakes. Those results are shown in Table 3.

TABLE 3
Particle size data for strawberry flakes
and agglomerated strawberry flakes.

| | MV (um) | MN (um) | MA (um) |
|---|---|---|---|
| Strawberry Flakes | 227.4 | 45.63 | 141.7 |
| Agglomerated Strawberry | 283.3 | 90.83 | 207.4 |
| Flakes | | | |

What is claimed is:

1. A method for encapsulating at least one target ingredient with and within dried fruit flakes, the method comprising the steps of
a. admixing at least one fruit flake and at least one dry-particle target ingredient to produce a fruit flake/target ingredient mixture, wherein the fruit flake/target ingredient mixture comprises from about 40 to about 70 percent fruit flakes and from about 25 to about 60 percent target ingredient, by dry weight of the fruit flake/target ingredient mixture;
b. adding the fruit flake/target ingredient mixture to an agglomerator;
c. wetting the fruit flake/target ingredient mixture at a temperature of from about 40 to about 60 degrees Celsius until the at least one target ingredient is substantially incorporated into agglomerates formed by the combination of the at least one fruit flake and the at least one target ingredient; and
d. drying the agglomerates formed by the combination of the at least one fruit flake and the at least one target ingredient to form at least one target ingredient in a fruit flake carrier, which, upon contact with a sufficient amount of water to promote the dissolution of the fruit flake carrier, will release the at least one target ingredient.

2. The method of claim 1 wherein steps of wetting, agglomerating, and drying are performed by, and within, the agglomerator.

3. The method of claim 1 wherein the target ingredient is selected from the group consisting of at least one flavor, color, vitamin, mineral, protein, fat, carbohydrate, processing aid, binder, emulsification agent, bioactive, and combinations thereof.

4. The method of claim 1 wherein the fruit flake comprises at least one fruit selected from the group consisting of strawberries, blueberries, blackberries, peaches, plums, apples, and combinations thereof.

5. The method of claim 1 wherein the fruit flake comprises at least one vegetable selected from the group consisting of corn, potatoes, rice, and combinations thereof.
